(19) United States
(12) Patent Application Publication
(10) Pub. No.: US 2018/0162202 A1
(43) Pub. Date: Jun. 14, 2018

(54) SUN VISOR FOR AUTOMOBILE

(71) Applicant: YUMEKOUBOU CO., LTD., Osaka (JP)

(72) Inventor: Kazuo Yoshimi, Osaka-shi (JP)

(73) Assignee: YUMEKOUBOU CO., LTD., Osaka (JP)

(21) Appl. No.: 15/817,438

(22) Filed: Nov. 20, 2017

(30) Foreign Application Priority Data
Dec. 14, 2016 (JP) 2016-242191

(51) Int. Cl. B60J 3/02; B60J 3/00

(52) U.S. Cl. CPC B60J 3/0278; B60J 3/007

(57) ABSTRACT

A sun visor for automobile has sliding functions and angle adjusting functions which can move and rotate a screen to shield a light flexibly, and can be arranged in response to the position of a light source and the incident angle. The sun visor for automobile comprises a clip part having a smooth bottom surface, a hinge part, a joint part and an almost plate-like first screen made of a material having shielding property. An upper portion of the hinge part is connected to a bottom surface of the clip part to freely achieve sliding movement and angle adjusting in the front-back direction. An upper portion of the joint part is connected to a lower portion of the hinge part to freely achieve angle adjusting in the crosswise direction. The first screen is connected to a lower portion of the joint part to freely achieve slide in the crosswise direction.

### TECHNICAL FIELD

The present invention relates to a sun visor for automobile which can be fastened to a light shielding plate provided in a car and can shield lights entered from outside into the car more suitably.

It is a great factor for a car driver to prevent from safe and comfortable driving when luminous energy entering into his field of view decreases or increases unnecessarily. Particularly, during daytime, depending to the position of sun, there are frequently happened that the sun light directly enters into the car to make a driver's field of view remarkably bad. Further, since driving direction of a car changes over time, it is necessary to take measures where the field of view can be continuously ensured against the sun light depending to the direction and angle of entered sun light. In such a case, for ensuring the field of view, a diver has shielded the light by using a light shielding plate previously provided in the car.

Further, when enough light shielding cannot be effected only by the light shielding plate, there is a case where an additional sun visor for automobile which is fastened to the light shielding plate. According to such a sun visor, the sun visor is fastened to the light shielding plate by a clip having a pivoting part, the sun visor varies an angle of the sun visor face in the front-back direction of a driver's visual line about the pivoting point the pivoting part, and an swing angle between the sun visor face and the light shielding plate is controlled according to entering direction of sun light or position of a light source, whereby a light shielding region where the light is shielded in the field of view can be determined (for example, Patent Document 1).

Furthermore, there is a product where a part which can clip the sun visor so as to slide the sun visor freely in the crosswise direction is connected to the lower position of the pivoting part of the fastening clip, and by sliding the sun visor in the crosswise direction, the sun visor can be positioned at a shielding position desired by a driver (for example, Patent Document 2).

### PRIOR TECHNICAL DOCUMENTS

### Patent Document

[Patent Document 1] JP2007-22516 A

[Patent Document 2] JP2011-161962 A

### SUMMARY OF THE INVENTION

### Problem to be Solved by the Invention

However, since the conventional sun visors only have the movable functions of the angle adjusting in the front-back direction and the sliding movement in the crosswise direction, it is not possible to act in response to the incident angle, direction and the position of light source which adversely affect to the driver's field of view. In addition, when a car enters to a shade area or the like to be in condition that the car would not be influenced by a light, since the sun visor itself shields the driver's field of view, it is necessary to remove the sun visor rapidly from the field of view. However, according to the conventional sun visors, since the movable part is small, rapid change of their arrangement cannot be achieved.

Studying the structures of the conventional sun visors, since the movable part to move and rotate the shielding face of the sun visor is small, it is apparent that the position of the face of the sun visor cannot be changed flexibly due to the situation, and thus there is a room for improvement.

Considering the above problems, the purpose of the present invention is to provide a sun visor for automobile that has a plurality of sliding functions and angle adjusting functions which can move and rotate a screen to shield a light flexibly, and can be arranged in response to the position of a light source and the incident angle by adjusting freely the position and angle in the front-back direction and the position and angle in the crosswise direction.

### Means to Solve the Problem

In order to solve the above problem, the present invention provides a sun visor for automobile, which comprises:

a clip part having a smooth bottom surface,

a hinge part,

a joint part,

an almost plate-like first screen made of a material having shielding property which is connected to the clip part via the hinge part and the joint part, and

an almost plate-like second screen made of a material having shielding property higher than that of the first screen, and has a crosswise length shorter than that of the first screen,

wherein

an upper portion of the hinge part is connected to a bottom surface of the clip part so as to freely achieve sliding movement and angle adjusting in the front-back direction,

an upper portion of the joint part is connected to a lower portion of the hinge part so as to freely achieve angle adjusting in the crosswise direction,

the first screen is connected to a lower portion of the joint part so as to freely achieve slide in the crosswise direction, and

the second screen is connected above the both of the first screen and the second screen so as to adjust an angle to the first screen freely.

Further, the present invention can provide a sun visor for automobile, which comprises:

a clip part having a smooth bottom surface,

a hinge part,

a joint part and

an almost plate-like first screen made of a material having shielding property, wherein

an upper portion of the hinge part is connected to a bottom surface of the clip part so as to freely achieve sliding movement and angle adjusting in the front-back direction,

an upper portion of the joint part is connected to a lower portion of the hinge part so as to freely achieve angle adjusting in the crosswise direction, and

the first screen is connected to a lower portion of the joint part so as to freely achieve slide in the crosswise direction.

According to the sun visor for automobile of the present invention having such a configuration, the first screen having light shielding property is connected to the clip part through the joint part and the hinge part which have the mechanism where the screen can be adjusted in the front-back direction and in the crosswise direction. Further, since the first screen is connected to the joint part by engaging a second sliding rail which is provided at an upper portion of the first screen with a second rail clipping part which is provided at an under portion of the joint part, the first screen can be slid in the crosswise direction within a given movable distance (length of the longitudinal direction of the second sliding rail). Furthermore, since the clip part is connected to the hinge part by engaging a first sliding rail which is provided at the smooth surface of the clip part with a first rail clipping part which is provided with the sliding part of the hinge part, the clip part can be slid in the front-back direction within a given movable distance (length of the longitudinal direction of the first sliding rail).

As mentioned above, the sun visor for automobile of the present invention has a plurality of sliding functions and angle adjusting functions, and the first screen can be arranged in response to the position of a light source and the incident angle by adjusting freely the position and angle in the front-back direction and the position and angle in the crosswise direction.

In the sun visor for automobile of the present invention, it is desirable that the first screen has a second screen. The first screen and the second screen may have the same or different shielding property (degree of shielding).

Further, in the sun visor for automobile of the present invention, it is desirable that the second screen is connected to the first screen at one edge of the four edges, and the connecting part is so configured as to freely achieve the angle adjusting in the front-back direction or in the crosswise direction.

According to the sun visor for automobile of the present invention having such a configuration, by using the second screen, when entering a strong light which cannot be protected by using the first screen alone, the shielding efficiency can be improved by laminating the both.

Further, an angle of the second screen relative to the first screen can be adjusted by the connecting part of the first screen and the second screen in the front-back direction and in the crosswise direction. Thereby, for example, when a light enters through a space formed between the upper side of the first screen and the lower side of the clip part to prevent the driver's field of view or the like, it is possible to shield the light which enters through the space by moving the second screen in the front direction, while keeping the arrangement of the first screen.

### BRIEF EXPLANATION OF DRAWINGS

FIG. 1 is a perspective view for explaining the configuration of the sun visor 1 for automobile according to the present embodiment.

FIGS. 2A to 2C include views for explaining the configuration of the clip part 3 shown in FIG. 1. FIG. 2A is a plan view of the clip part 3, FIG. 2B is a side view of the clip part 3, and FIG. 2C is a bottom view of the clip part 3.

FIGS. 3A to 3C include views for explaining the configuration of the hinge part 5 shown in FIG. 1. FIG. 3A is a front view of the hinge part 5, FIG. 3B is a side view of the hinge part 5, and FIG. 3C is a plan view of the hinge part 5.

FIGS. 4A to 4C include views for explaining the configuration of the joint part 7 shown in FIG. 1. FIG. 4A is a front view of the joint part 7, FIG. 4B is a side view of the joint part 7, and FIG. 4C is a sectional view of the joint part 7 from the arrow A in FIG. 4B.

FIGS. 5A and 5B include views for explaining the configuration of the first screen 9 shown in FIG. 1. FIG. 5A is a front view of the first screen 9, and FIG. 5B is a side view of the first screen 9.

FIGS. 6A and 6B include views for explaining the configuration of the second screen 11 shown in FIG. 1. FIG. 6A is a front view of the second screen 11, and FIG. 6B is a side view of the second screen 11.

FIGS. 7A and 7B include views for explaining the sliding function and the angle adjusting function in the front-back direction which are provided in the sun visor 1 for automobile of the present embodiment. FIG. 7A is a schematic view showing the sliding function in the front-back direction, and FIG. 7B is a schematic view showing the angle adjusting function in the front-back direction.

FIG. 8 is a schematic view showing the angle adjusting function in the crosswise direction which is provided in the sun visor 1 for automobile of the present embodiment.

FIG. 9 is a schematic view showing the angle adjusting function in the front-back direction of the second screen 11 shown in FIG. 1.

### MODE TO CARRY OUT THE INVENTION

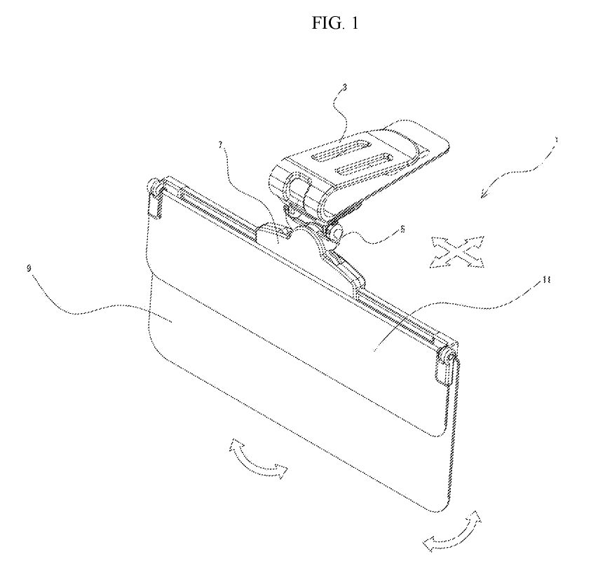

In the following, typical embodiments of the sun visor 1 for automobile according to the present invention is explained in detail by referring FIG. 1 to FIG. 9, but the present invention is not limited to the embodiments shown in the drawings. In addition, since these drawings are presented to explain the concept of the present invention, in order to contribute easy understanding, there are cases where size, ratio or number is represented in exaggerated or simplified manner, if necessary. Further, in the following explanation, the same symbol is given to the same or corresponding parts, and there is a case where overlapping explanation is omitted.

### 1. Configuration of the Sun Visor 1 for Automobile

### <Summary of the Sun Visor 1 for Automobile>

The sun visor 1 for automobile of the present embodiment is to shield an external light such as sun light which enters to a driver's field of view suitably, and connected to the upper side of the driver's sheet of a car, preferably to a light shielding plate which is previously provided inside of the car. Further, according to the sun visor 1 for automobile of the present embodiment, it is possible to achieve optionally the sliding adjustment in the front-back direction, the angle adjusting in the front-back direction, and the angle adjusting in the crosswise direction within a given range in response to the angle of entering light and the position of driver's eyes to realize the shielding of light more exactly, and thus, safe and convenient driving circumstance can be provided.

By referring FIG. 1, the configuration of the sun visor 1 for automobile according to the present embodiment is explained. FIG. 1 is a perspective view for explaining the configuration of the sun visor 1 for automobile according to the present embodiment.

As shown in FIG. 1, the sun visor 1 for automobile of the present embodiment comprises a clip part 3 which clips a sun visor (light shielding plate) which is previously provided in a car usually, an almost plate-like first screen 9 having shielding property, a second screen 11 which is connected to the first screen 9 and has different shielding property (degree of shielding), a hinge part 5 and a joint part 7 which connect the clip part 3 to the first screen 9. The shielding properties (degrees of shielding) of the first screen 9 and the second screen 11 may be the same or different. For example, for a driver who feels a light entered from a space where the first screen 9 cannot shield so bright, it is preferable that the shielding property (degree of shielding) of the second screen 11 is made high.

### <Configuration of Clip Part 3>

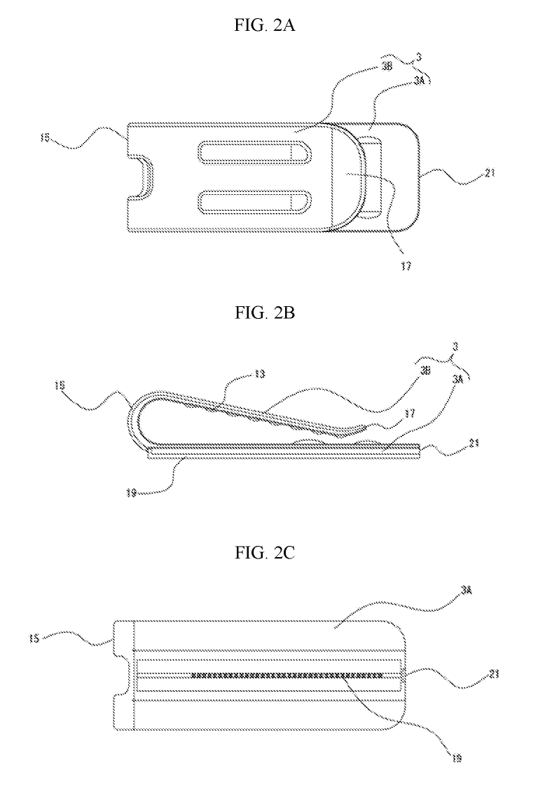

Next, by referring FIGS. 2A, 2B, and 2C, the configuration of the clip part 3 is explained in detail. FIGS. 2A, 2B, and 2C are views for explaining the configuration of the clip part 3. FIG. 2A is a plan view of the clip part 3, FIG. 2B is a side view of the clip part 3, and FIG. 2C is a bottom view of the clip part 3.

As shown in FIGS. 2A, 2B, and 2C, the clip part 3 is a plate-like part which is bended at a part thereof, and is configured almost by a smooth part 3A at the bottom side and a folded part 3B. The clip part 3 is provided at the uppermost portion of the sun visor 1 for automobile according to the present embodiment, and the sun visor 1 for automobile according to the present embodiment is fixed to a car by clipping, for example, the light shielding plate which is previously provided inside of the car between the smooth part 3A and the folded part 3B.

As shown in FIG. 2B, the folded part 3B has a configuration where a bended part 15 is separated furthest from the smooth part 3A and a top edge 17 is closed nearest thereto. A part of the top edge 17 is bended outside (in the opposite direction to the smooth part 3A), and thereby the light shielding plate can be easily inserted between the smooth part 3A and the folded part 3B.

Further, a plurality of projections 13 are provided on the both opposed surfaces of the smooth part 3A and the folded part 3B, and, when clipping the light shielding plate, the projections 13 can grip the light shielding plate from upper and lower sides to improve the gripping force of the clip part 3. The shape and size of the projections 13 may be the same, or may be different depending to the position, or the like.

As shown in FIG. 2C, on the rear side of the surface of the smooth part 3A which is opposite to the folded part 3B, a first sliding rail 19 is provided. The first sliding rail 19 is formed almost parallel to the longitudinal direction of the smooth part 3A between the position near the bending part 15 and a top edge 23 (21), and connected to the hinge part 5 as explained below.

Furthermore, it is desirable that the clip part 3 is improved in safety and weight reduction by subjecting to chamfering treatment of convex corners (edges) and to thinning treatment depending to strength of the material to be used.

### <Configuration of Hinge Part 5>

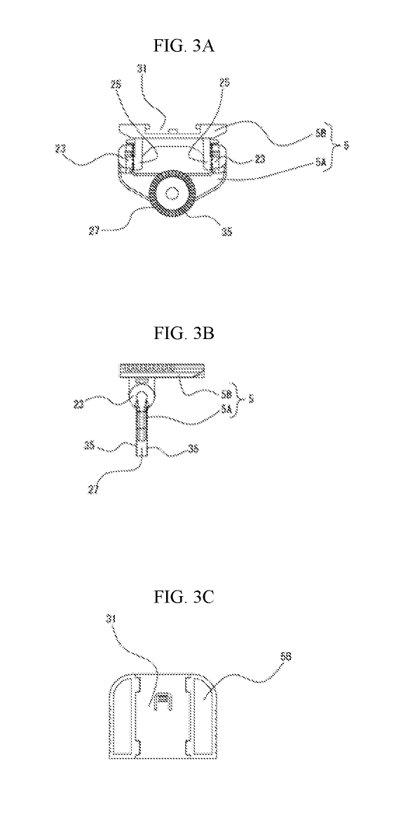

Next, by referring FIGS. 3A, 3B, and 3C, the configuration of the hinge part 5 is explained in detail. FIGS. 3A, 3B, and 3C are views for explaining the configuration of the hinge part 5. FIG. 3A is a front view of the hinge part 5, FIG. 3B is a side view of the hinge part 5, and FIG. 3C is a plan view of the hinge part 5.

As shown in FIGS. 3A, 3B, and 3C, the hinge part 5 is configured almost by a rotary part 5A and a sliding part 5B, and is a part for adjusting the position and angle of the sun visor 1 for automobile according to the present embodiment.

The rotary part 5A provides with a first connecting part 23 for connecting to the sliding part 5B and a third connecting part 27 for connecting to the joint part 7 mentioned below. The first connecting part 23 is arranged so that, above the rotary part 5A, two connecting surfaces are faced to each other while their centers are concentric, and the third connecting part 27 is arranged so as to face to the outside, at almost the center of the rotary part 5A, while two connecting surfaces are concentric.

The sliding part 5B provides with a second connecting part 25 for connecting to the rotary part 5A and a first rail clipping part 31 for connecting to the first sliding rail 19 of the clip part 3. The second connecting part 25 is arranged so that, under the sliding part 5B, two connecting surfaces are faced to the outside while their centers are concentric, and the first rail clipping part 31 is engaged so as to be able to slide along the first sliding rail 19 of the clip part 3.

The rotary part 5A and the sliding part 5B are connected so as to rotate (angle-adjust) freely in the manner that both connecting surfaces of the first connecting part 23 of the rotary part 5A and the second connecting part 25 of the sliding part 5B are concentric. Further, on the both connecting surfaces of the first connecting part 23 and the second connecting part 25, there are formed gears 35 where gears are formed radially from the center, and thus, it is possible to rotate stepwise the first connecting part 23 and the second connecting part 25 depending to the formed pitches of the gear 35. Namely, since the rotary part 5A and the sliding part 5B can be fixed at a desired point by an optional rotation angle by varying the formed pitch of the gear 35, angle adjusting of the parts can be simply achieved.

The third connecting part 27 of the rotary part 5A also has a gear 35 in the same manner as in the first connecting part 23 and the second connecting part 25.

### <Configuration of Joint Part 7>

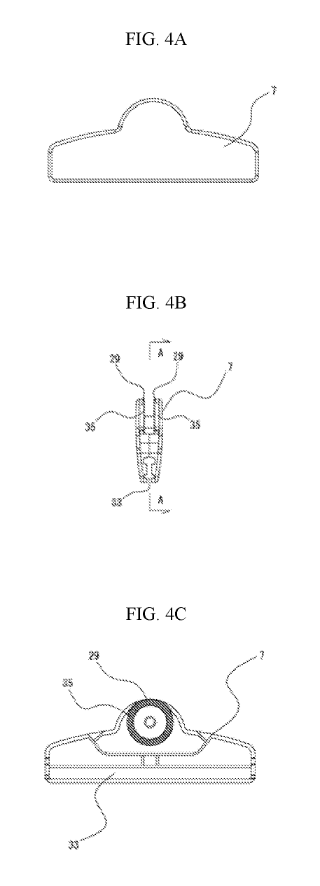

Next, by referring FIGS. 4A, 4B, and 4C, the configuration of the joint part 7 is explained in detail. FIGS. 4A, 4B, and 4C are views for explaining the configuration of the joint part 7. FIG. 4A is a front view of the joint part 7, FIG. 4B is a side view of the joint part 7, and FIG. 4C is a sectional view of the joint part 7 from the arrow A in FIG. 4B.

As shown in FIGS. 4A, 4B, and 4C, the joint part 7 is configured almost by a forth connecting part 28 which is connected to the third connecting part 27 of the rotary part 5A and a second rail clipping part 33 which is connected to the first screen 9 mentioned below.

The forth connecting part 28 is arranged so that, at almost the center of the joint part 7, two connecting surfaces are faced to each other while their centers are concentric, and the second rail clipping part 33 is engaged so as to be able to slide along a second sliding rail 20 of the first screen 9 mentioned below.

The joint part 7 and the rotary part 5A are connected so as to rotate (angle-adjust) freely by covering the forth connecting part 28 of the joint part 7 with the third connecting part 27 of the rotary part 5A from outside so that the centers of the both connecting parts are concentric. Further, since the connecting surface of the forth connecting part 28 has a gear 35 in the same manner as in the first, second and third connecting parts, the connecting angle between the joint part 7 and the rotary part 5A can be adjusted stepwise.

### <Configuration of First Screen 9>

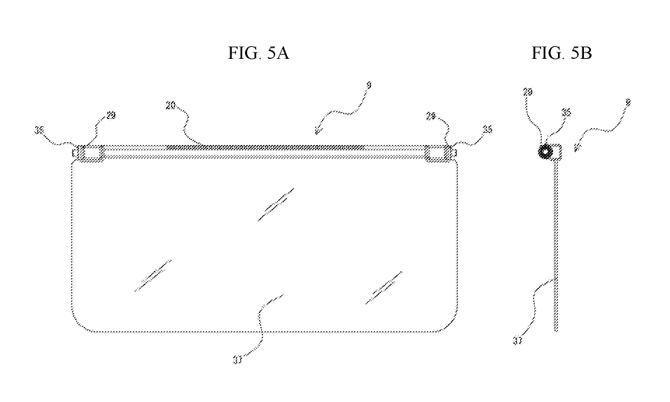

Next, by referring FIGS. 5A and 5B, the configuration of the first screen 9 is explained in detail. FIGS. 5A and 5B are views for explaining the configuration of the first screen 9. FIG. 5A is a front view of the first screen 9, and FIG. 5B is a side view of the first screen 9.

As shown in FIGS. 5A and 5B, the first screen 9 is configured almost by a light shielding plate 37 for shielding a light, a first sliding rail 19 (20) which is connected above the light shielding plate 37 and engaged with the second rail clipping part 33 of the joint part 7, and a fifth connecting part 29 which is connected to the second screen 11 mentioned below.

The light shielding plate 37 is an almost plate-like part made of a resin or the like having light shielding property, and can shield lights such as sunlight. The light shielding plate 37 is preferably made of a material having a low light transmittance used for sun glasses, and may be a product where a polaroid filter which can shield only a light entered from the specific direction is laminated, or may be a product which is subjected to surface emboss processing to reduce light transmittance.

The first sliding rail 19 (20) is provided above the light shielding plate 37 and along the longitudinal direction of the light shielding plate 37, and is engaged with the second rail clipping part 33 of the joint part 7. The sliding distance between the first sliding rail 19 (20) and the joint part 7 is determined depending to the length of the first sliding rail 19 (20).

Further, the first sliding rail 19 (20) has the fifth connecting parts 29 at the both ends, and are arranged so that two connecting surfaces of the fifth connecting part 29 are faced to each other while their centers are concentric.

### <Configuration of Second Screen 11>

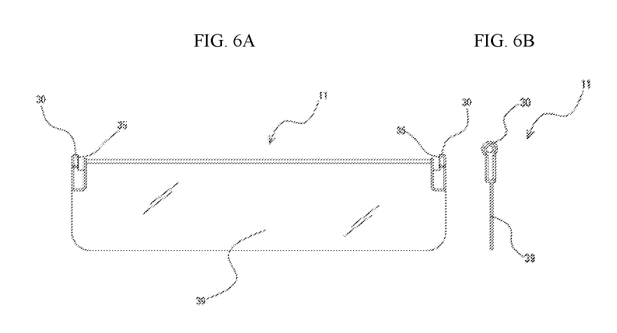

Next, by referring FIGS. 6A and 6B, the configuration of the second screen 11 is explained in detail. FIGS. 6A and 6B are views for explaining the configuration of the second screen 11. FIG. 6A is a front view of the second screen 11, and FIG. 6B is a side view of the second screen 11.

As shown in FIGS. 6A and 6B, the second screen 11 is configured almost by a small light shielding plate 39, and a sixth connecting part 30 which is connected to the fifth connecting part 29 of the first screen 9.

The small light shielding plate 39 is an almost plate-like part made of a resin or the like having light shielding property, and can shield lights such as sunlight more highly in comparison with the light shielding plate 37 of the first screen 9. Therefore, it is preferable to be made of a material having a lower light transmittance than that of the light shielding plate 37.

Further, the longitudinal length of the small light shielding plate 39 is almost the same as that of the light shielding plate 37, but the crosswise length is shorter than that of the light shielding plate 37.

The sixth connecting part 30 is provided at the both ends of the upper side of the small light shielding plate 39 in the manner that two connecting surfaces of the sixth connecting part 30 are facing to the outside, while two connecting surfaces are concentric. The first screen 9 and the second screen 11 are connected in the manner that the second screen 11 is engaged by covering the fifth connecting part 29 of the first screen 9 with the sixth connecting part 30 from outside so that the centers of the both connecting parts are concentric to rotate (angle-adjust) freely.

### 2. Method for Using Sun Visor 1 for Automobile

### <Sliding Function and Angle-Adjusting Function by Sun Visor 1 for Automobile>

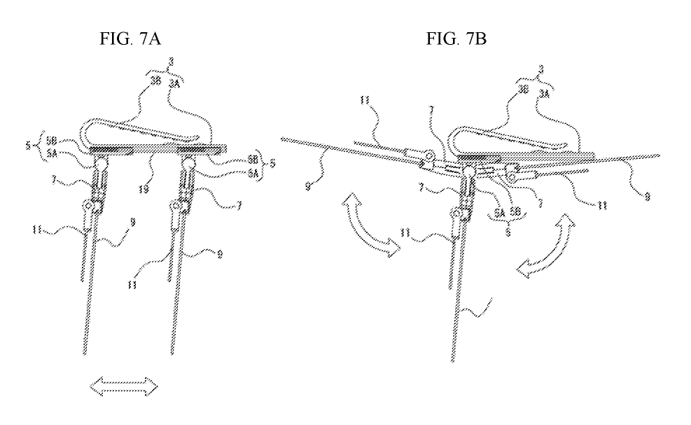

Next, by referring FIG. 7A to FIG. 9, the sliding function and the angle adjusting function which are provided in the sun visor 1 for automobile of the present embodiment are explained. FIGS. 7A and 7B are views for explaining the sliding function and the angle adjusting function in the front-back direction which are provided in the sun visor 1 for automobile of the present embodiment. FIG. 7A is a schematic view showing the sliding function in the front-back direction, and FIG. 7B is a schematic view showing the angle adjusting function in the front-back direction.

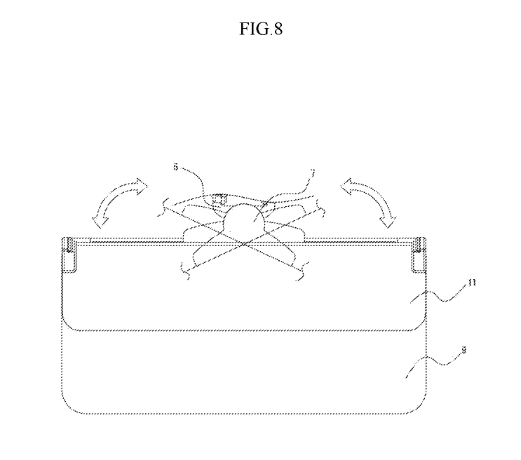

Further, FIG. 8 is a schematic view showing the angle adjusting function in the crosswise direction which is provided in the sun visor 1 for automobile of the present embodiment.

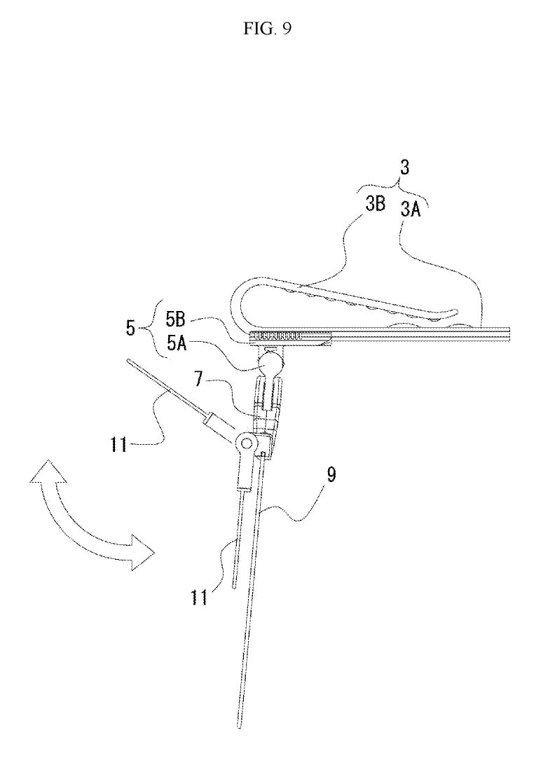

Furthermore, FIG. 9 is a schematic view showing the angle adjusting function in the front-back direction of the second screen 11.

As mentioned above, the sun visor 1 for automobile has a plurality of sliding function and angle adjusting function for realizing the optimum light shielding in response to the light entering position and angle of lights such as sunlight. Firstly, as shown in FIG. 7A, the first screen 9 and the second screen 11 can be slid in the front-back direction by engaging the clip part 3 and the hinge part 5 to adjust the position. More specifically, since the first sliding rail 19 of the smooth part 3B of the clip part 3 and the sliding part 5B of the hinge part 5 are engaged slidably, the position of the sliding part 5B can be optionally fixed within the movable distance corresponding to the length of the first sliding rail 19.

Further, as shown in FIG. 7B, by changing the relation of connection between the first connecting part 23 of the rotary part 5A and the second connecting part 25 of the sliding part 5B, the angle in the front-back direction between the first screen 9 and the second screen 11 can be adjusted within a given angle range around the center where the first connecting part 23 and the second connecting part 25 are connected.

Furthermore, as shown in FIG. 8, by changing the relation of connection between the third connecting part 27 of the rotary part 5A and the forth connecting part 28 of the joint part 7, the angle in the crosswise direction between the first screen 9 and the second screen 11 can be adjusted within a given angle range around the center where the third connecting part 27 and the forth connecting part 28 are connected.

As shown in FIG. 9, by changing the relation of connection between the fifth connecting part 29 of the first screen 9 and the sixth connecting part 30 of the second screen 11, the angle in the front-back direction between the first screen 9 and the second screen 11 can be adjusted within a given angle range around the center where the fifth connecting part 29 and the sixth connecting part 30 are connected.

Since the distance and angle arrangement between the driver's eyes and the first screen 9 and second screen 11 can be adjusted sensitively by using a plurality of the aforementioned sliding function and angel adjusting function, it is possible to arrange the first screen 9 and the second screen 11 to the optimum position and angle by adjusting in response to the position and entering angle of light. Further, in case that the second screen 11 is provided, when entering a strong light which cannot be protected by using the first screen 9 alone, the shielding efficiency can be improved by laminating the both, and, for example, when a light enters through a space formed between the upper side of the first screen 9 and the lower side of the clip part 3 to prevent the driver's field of view or the like, it is possible to shield the light which enters through the space by moving the second screen 11 in the front direction, while keeping the arrangement of the first screen 9.

As mentioned above, since the sun visor 1 for automobile of the present embodiment has a plurality of the sliding function and angle adjusting function, it is possible to achieve the optimum arrangement by determining the angle and position flexibly while maintaining the distance from the driver's eyes in response to the entering direction and angle of a light which prevents the driver's view, and the position of light source, etc.

In the above, one embodiment of the present invention is explained by referring the drawings, and the present invention is not limited to the embodiment, and there are other improved embodiments and modified embodiments within the scope of the concept and teaching claimed in the patent claims. Therefore, it is easy to understand for a person skilled in the art that those improved embodiments and modified embodiments are included in the scope of the present invention. For example, in the sun visor for automobile of the present invention, the hinge part and the joint can be integrated to form a single part and, in that case, the hinge part and the joint may not be moved with each other.

### INDUSTRIAL APPLICABILITY

According to the sun visor for automobile of the present invention, since the sun visor that has a plurality of sliding functions and angle adjusting functions which can move and rotate a screen to shield a light flexibly, and the sun visor can be arranged in response to the position of a light source and the incident angle by adjusting freely the position and angle in the front-back direction and the position and angle in the crosswise direction.

### EXPLANATION OF SYMBOLS

1 Sun visor for automobile
3 Clip part
3A Smooth part
3B Folded part
5 Hinge part
5A Rotary part
5B Sliding part
7 Joint part
9 First screen
11 Second screen
13 Projections
15 Bending part
17 Top edge
19 First sliding rail
20 Second sliding rail
21 Top edge
23 First connecting part
25 Second connecting part
27 Third connecting part
28 Forth connecting part
29 Fifth connecting part
30 Sixth connecting part
31 First rail clipping part
33 Second rail clipping part
35 Gear
37 Light shielding plate
39 Small light shielding plate

1. A sun visor for automobile, comprising:
a clip part having a smooth bottom surface,
a hinge part,
a joint part and
an almost plate-like first screen made of a material having shielding property, wherein
an upper portion of the hinge part is connected to a bottom surface of the clip part so as to freely achieve sliding movement and angle adjusting in the front-back direction,
an upper portion of the joint part is connected to a lower portion of the hinge part so as to freely achieve angle adjusting in the crosswise direction, and
the first screen is connected to a lower portion of the joint part so as to freely achieve slide in the crosswise direction.

2. The sun visor for automobile in accordance with claim 1, wherein the first screen has a second screen.

3. The sun visor for automobile in accordance with claim 1, wherein the second screen is connected to the first screen at one edge of the four edges, and the connecting part is so configured as to freely achieve the angle adjusting in the front-back direction or in the crosswise direction.

4. The sun visor for automobile in accordance with claim 2, wherein the second screen is connected to the first screen at one edge of the four edges, and the connecting part is so configured as to freely achieve the angle adjusting in the front-back direction or in the crosswise direction.
